(19) United States
(12) Patent Application Publication
(10) Pub. No.: US 2026/0291761 A1
(43) Pub. Date: Sep. 24, 2026

(54) METHOD, SYSTEM AND CHIP FOR IDENTIFICATION AND/OR AUTHENTICATION

(71) Applicant: Sandgrain B.V., Eindhoven (NL)

(72) Inventors: Jeroen Mathias DOUMEN, Eindhoven (NL); Casparus Anthonius Henricus JUFFERMANS, Eindhoven (NL)

(21) Appl. No.: 19/476,232

(22) PCT Filed: Apr. 18, 2024
(86) PCT No.: PCT/IB2024/053784

§ 371 Date: Oct. 17, 2025

(30) Foreign Application Priority Data
Apr. 18, 2023 (NL) 2034622

(51) Int. Cl. H04L 9/32

(52) U.S. Cl. CPC H04L 9/3271; H04L 9/3242

(57) ABSTRACT

An authentication system receives an identity message, wherein the identity message is generated by the end node on the basis of the identity value (ID) stored in the end node and receives a challenge-response message, wherein the challenge-response message is generated by the end node on the basis of a pre-determined first function, the challenge message, and the authentication value stored in the end node. The authentication system verifies the received identity message on the basis of the first value and verifies the received challenge-response message on the basis of the second value, the challenge message, and a pre-determined first function, so as to obtain a verification result. The authentication system outputs authentication result on the basis of the verification result.

### TECHNICAL FIELD

The present invention relates to an authentication system, an integrated circuit, an end node device and a security method for centralized authentication.

### BACKGROUND ART

Over the last three decades, integrated circuit (IC)-based identification and security-based technologies and associated devices have reached a broad set of applications. Well-known examples are public transport ticketing, smart card conditional access systems for TV subscriptions, SIM cards in mobile phones, electronic passports, banking or credit cards, and labeling for tracking and managing logistic flows and transport. Volumes associated with these applications run in the billions of ICs per year. However, there are potentially many more applications that could use these technologies, that could further multiply these volumes by several orders of magnitude, so indeed hundreds of billions or trillions of IC's. So far this is not happening for two fundamental reasons: security and cost.

A main problem in the world of identification and security is hacking. Existing identification and security applications are typically built around so-called secure microcontrollers. Microcontroller units (MCU) are required for functions like authentication or security key generation, and storing of the relevant data in such a way that it is not accessible for intruders. Because MCUs typically operate under an operating system and a specific program, e.g. firmware program, to execute the required functions, they are typically a combined hardware (HW) and software (SW) solution.

Known systems have as a major drawback that they can be hacked. This in practice means reverse engineering the function of the device by analyzing its HW and/or SW behavior, resulting in the discovery of e.g. a secret (cryptographic) key as typically required in these known systems and stored in a memory. In a worst case scenario the memory content of the device is altered, e.g. by increasing the amount of credits on a transit card or changing the balance on a bank card. Although suppliers of these ICs and systems implement measures to make their ICs robust to hacking, in the end most systems are vulnerable and can be hacked, albeit at often high technological effort.

The other problem with existing security solutions is related to cost. With high-volume applications of IC related security solutions, an obvious requirement is to have the IC cost as low as possible. Today's ICs typically cost a few dollar cents, which multiplies by a factor four for the final assembled module or package sales price. Elements that increase the IC cost are the MCU infrastructure and the programmable on-chip memories. Typical elements that increase the IC cost are:
Secure MCUs are expensive, either as in-house development or as purchased IP, e.g. as ARM™ Secure Cores;
MCUs are complex functions, and although the core is relatively small in advanced technology, it requires all kind of peripheral functionality to make it work properly: communication busses, memories (usually a combination of multiple specific memories, like RAM, ROM, Flash), start-on and advanced power management circuitry. So, the total function is much bigger, and requires serious design effort;
The simplest identification products don't require re-programmable memories or keys. But even so, during manufacturing of the IC the code needs somehow be written in its memory. In most cases thus is done using One Time Programmable Read Only Memories (OTP-ROM), but these IP blocks are big, and require high voltage supply, making them large and thus expensive;
More complex identification and security ICs have programmable key or data storage, which requires re-programmable Non-Volatile Memory (NVM), often also referred to as flash memory. But flash memories are expensive technology features, requiring—depending upon the size of the baseline CMOS node—10 to 12 additional mask layers in production. This can be a cost adder of typically 35 to 30% compared to non-flash baseline technology wafer cost;
Identification and security ICs have a complex Back End (BE) process in the assembly and packaging fab, since every ICs requires pre-programming with its secure SW and—in case of non-programmable ICs—the embedded keys or identifiers.

The present invention recognizes as a fundamental problem that security requirements are highest at the end nodes of the system, and in particular in the devices (ICs) that are used by the consumers at very high volume, hence the system element that is most vulnerable to hacking. At the consumer side volumes are highest, so cost sensitivity is also highest. Because verification of security is typically done locally in the end node, once a device gets hacked or copied at user level, it cannot be identified as such by the system and misuse essentially goes undetected. Because the verification relies entirely on the end node device being authentic, hacked and copied devices can be deployed in large numbers undetected.

For many years these main factors block the originally predicted full global proliferation of identification and security solutions. And it is one of the main reasons for the delayed implementation of the Internet-of-Things (IoT) at consumer level.

The reason that the Identification and Security IC solutions of today are not optimal for tomorrow's requirements, is that they are essentially based on 25-year old concepts. At the time the internet and the cloud did not exist, and security had to be provided by an embedded MCU-based IC in the end node, in those days a real breakthrough.

In some applications, it might be necessary to protect against an adversary, who mimics the identity of a particular IC, and from then on can reproduce the particular IC without access to the IC. The authentication methods suffer from the same drawbacks as discussed above with relation to identification, and some of the standard methods are relatively slow and for example need a memory unit in order to work. Again, this memory unit can be attacked by an adversary. It is remarked that where WO2021240445 discloses how to facilitate identification, it is silent as to how a messenger of the ID can be authenticated.

### SUMMARY OF THE INVENTION

The present invention aims to solve the problems described in the prior art above.

The present invention enables identification and authentication that are much cheaper at the high-volume customer or user end of the chain, and shift complex security functionality away from those end nodes.

According to a first aspect of the invention an authentication method for authenticating the identity of an end node by an authentication system is proposed. The method can comprise storing, in the end node, an identity value and an authentication value, wherein the identity value and/or the authentication value is hard-coded into an integrated circuit in the end node; storing, in the authentication system, a first value associated with the integrated circuit in the end node, wherein a different first value is stored for each different identity value; storing, in the authentication system, a second value associated with the integrated circuit in the end node, wherein a different second value is stored for each different authentication value; receiving a challenge message by the end node; receiving, by the authentication system, an identity message, wherein the identity message is generated by the end node on the basis of the identity value stored in the end node; receiving, by the authentication system, a challenge-response message, wherein the challenge-response message is generated by the end node on the basis of a pre-determined first function, the challenge message, and the authentication value stored in the end node; verifying, by the authentication system, the received identity message on the basis of the first value and verifying, by the authentication system, the received challenge-response message on the basis of the second value, the challenge message, and a pre-determined first function, so as to obtain a verification result; and outputting, by the authentication system, an authentication result on the basis of the verification result.

In an embodiment, the authentication value stored in the end node can be derived using a pre-determined initial value, an initial key specific to the integrated circuit in the end node, and a pre-determined second function.

In an embodiment, the pre-determined second function can be equal to the pre-determined first function.

In an embodiment, the initial key can correspond to the second value stored in the authentication system.

In an embodiment, the pre-determined first function and the pre-determined second function can be hash functions, and the authentication value can be a hash output of the pre-determined second function.

In an embodiment, the pre-determined first and second functions each form a cryptographic hash function of a hash-based message authentication code.

In an embodiment, verifying the received identity message can comprise verifying whether the first value corresponds to the contents of the identity message.

In an embodiment, verifying the received challenge-response message can comprise: generating a challenge-response value on the basis of the second value, the challenge message, and the pre-determined first function; and verifying whether the challenge-response value corresponds to the contents of the challenge-response message.

According to a second aspect of the invention an authentication system is proposed. The system can comprise a plurality of end nodes, wherein in each end node an identity value and an authentication value is stored, wherein the identity value and/or the authentication value is hard-coded into an integrated circuit in the end node; a data storage system arranged to store for each end node a first and second value associated with the integrated circuit in the end node, wherein a different first value is stored for each different identity value and a different second value is stored for each different authentication value; a terminal arranged to transmit a challenge message to an end node, and receive from the end node an identity message and a challenge-response message, wherein the identity message is generated by the end node on the basis of the identity value stored in the end node, and wherein the challenge-response message is generated by the end node on the basis of a pre-determined first function, the challenge message, and the authentication value stored in the end node; a server arranged to verify the received identity message for the end node on the basis of the first value, and verify the received challenge-response message for the end node on the basis of the second value, the challenge message, and the pre-determined first function, so as to obtain a verification result, and arranged to output an authentication result on the basis of the verification result for the end node.

In an embodiment, the terminal can be arranged to receive the challenge message for the end node from the server and transmit the identity message and the challenge-response message from the end node to the server.

In an embodiment, the authentication value can be obtained by using a pre-determined initial value, an initial key specific to the integrated circuit in the end node and a pre-determined second function.

In an embodiment, the pre-determined second function can be equal to the pre-determined first function.

In an embodiment, the initial key can correspond to the second value stored in the authentication system.

In an embodiment, the pre-determined first function and the pre-determined second function can be hash functions, and the authentication value can be a hash output of the pre-determined second function.

According to a third aspect of the invention an integrated circuit is proposed. The integrated circuit can comprise an identification value and/or an authentication value hard-coded in the integrated circuit, for use in the authentication system according to the second aspect of the invention.

Aspects and embodiments of the invention are further described in the following description and in the claims.

### BRIEF DESCRIPTION OF THE DRAWINGS

Embodiments will now be described, by way of example only, with reference to the accompanying schematic drawings in which corresponding reference symbols indicate corresponding parts, and in which:

FIG. 1 shows an exemplary authentication system according to an aspect of the invention;

FIG. 2 shows and exemplary IC according to an aspect of the invention;

FIGS. 3a-3d show exemplary end node devices including ICs according to an aspect of the invention;

FIGS. 3e-3f show exemplary assets including ICs according to an aspect of the invention;

FIG. 4 shows a time sequence diagram of an exemplary method of the invention;

FIG. 5 shows a schematic overview of an identification and authentication method according to a first embodiment;

FIG. 6 shows a schematic overview of an identification and authentication method according to a second embodiment;

FIG. 7A shows a schematic overview of a first hash pass 700 in a SHA-256 algorithm;

FIG. 7B shows a schematic overview of a second hash pass 700 in a SHA-256 algorithm;

FIG. 8 shows a schematic overview of an implementation of a hash-based message authentication code;

FIG. 9 shows a schematic overview of a high-level challenge-response flow in the IC;

FIG. 10 shows identification functionality of an IC;

FIGS. 11A-B show a schematic overview of an implementation of a identification and authentication method and its usage of clock cycles on the IC.

The figures are intended for illustrative purposes only, and do not serve as restriction of the scope or the protection as laid down by the claims.

### DESCRIPTION OF EMBODIMENTS

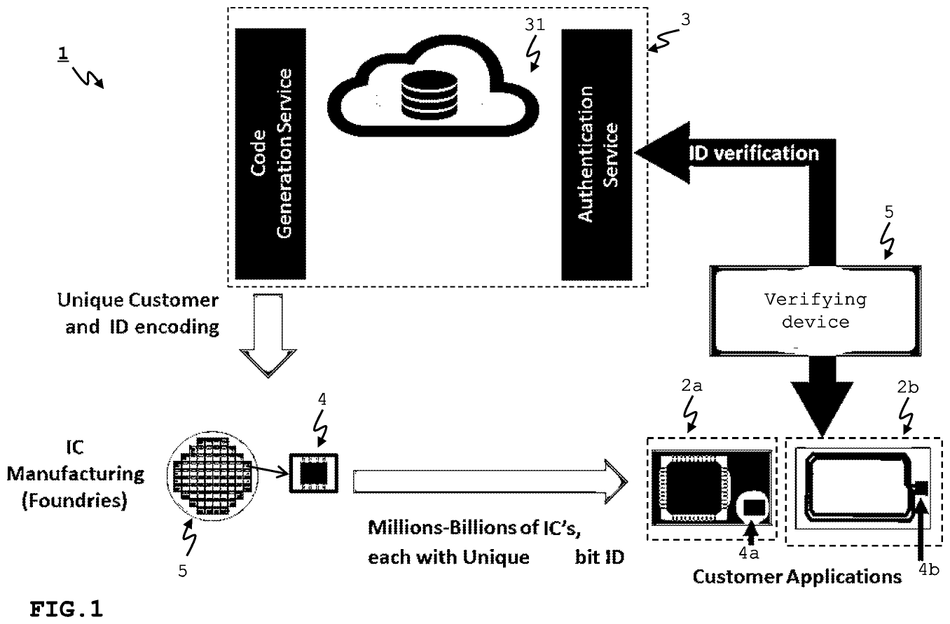

FIG. 1 shows an exemplary authentication system 1 according to an aspect of the invention. The authentication system 1 may include end node devices 2a, 2b each containing an IC 4a, 4b embedded with a unique identifier. The authentication system 1 may further include a verifying device 5 for requesting the identifier from the end node device. The authentication system 1 may further include a centralized code registration system 3, typically comprising an electronic database system 31.

The IC 4a, 4b is typically linked to an asset. The asset is e.g. an electronic device like a peripheral device, an industrial device or a medical device, or any taggable good like packing material or consumer goods. The assets have in common that they are identifiable by the identifier. It is possible that the end node device itself is the asset.

Querying of an IC 4a, 4b for its identifier may result in sending the identifier to the centralized code registration system 3, and the centralized code registration system 3 providing a verification result indicative of an authentication result. The identifier is typically transmitted to the centralized code registration system 3 after a request from the verifying device 5. The identifier may be transmitted from the end node device 2a, 2b to the centralized code registration system 3, via the verifying device 5, and/or via any other intermediate communication device (not shown).

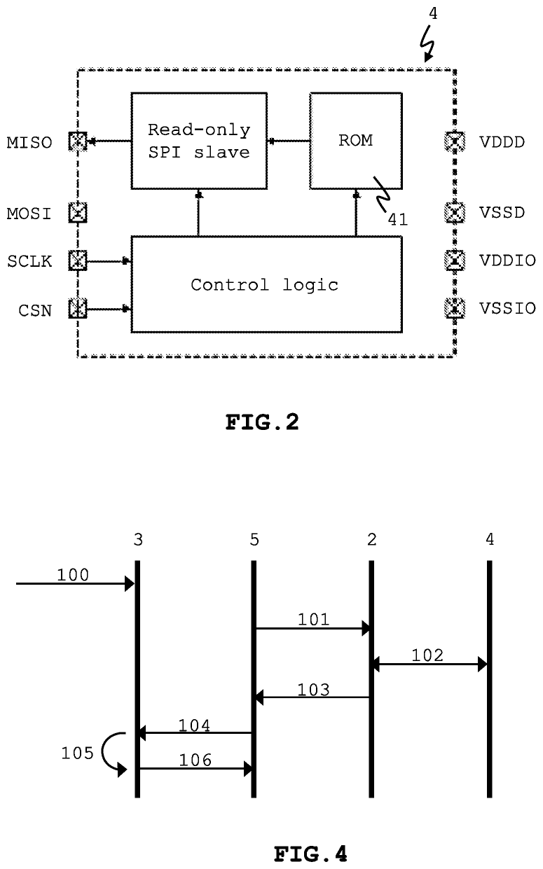

The unique identifier may be embedded in the IC 4a, 4b as a bit-code of predefined order of magnitude, hard coded in the IC 4a, 4b, typically in the form of a register and an interface for reading out the code, e.g. as shown in the IC 4 of FIG. 2. A non-limiting example of an identifier is a 128-bit code. These 128 bits allow the unique identification of 10³⁸ unique elements. It will be understood that identifiers may be defined using any other number of bits, such as 64, 80, 96, 128, 512, 1024 or any other number of bits. The identifier bits may be hard coded in the IC 4, 4a, 4b, so there are no options to re-write or modify the identifiers.

FIG. 2 shows an exemplary IC 4 according to an aspect of the present invention. The IC 4 may include a ROM register 41, e.g. a 128-bit (16×8) ROM embedding a 128-bit identifier. The IC 4 includes an interface, here embodied in the form of a Serial Peripheral Interface (SPI) and control logic for outputting the identifier on a request received via the Control logic. The IC 4 may include voltage inputs VDDD, VSSD, VDDIO and VSSIO. The IC 4 may further include signal inputs MOSI (Master Output Slave Input), SCLK (Serial CloCK) and CSN (Chip Select Not). The IC 4 may further include signal output MISO (Master Input Slave Output).

It will be understood that the IC 4 is not limited to having SPI-based interfaces. Other non-limiting examples of interfaces that may be used in the IC 4 are serial interface like I2C or I2S, 3-wire, 1-wire, USB or a classical 13.56 MHz RF-ID contactless interface. Moreover, it will be understood that the IC 4 is not limited to 16×8 ROM registers and that any other read-only register may be used for storing identifiers of any bit length.

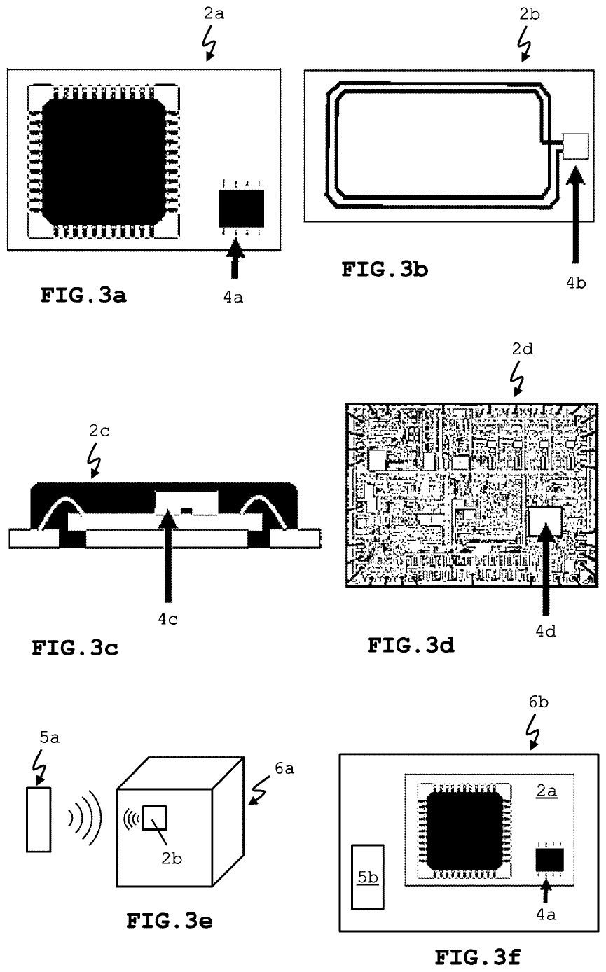

FIGS. 3a-3d show exemplary end node devices 2a-2d with embedded ICs 4a-4d according to the present invention.

FIG. 3a shows an exemplary miniature SO8-packaged IC 4a for board-level applications, which may be similar to the IC 4 of FIG. 2. The IC 4a may be used for authentication on board/system level. Any other suitable packaging may be used, e.g. SSOP8, TSSOP8, 8WLCSP, various leadless packages.

FIG. 3b shows an exemplary RF-ID compatible IC 4b, which may be used for object authentication. Most or all of the RF-ID functionality may be implemented in the end node device 2b interfacing with the IC 4b.

FIG. 3c shows an exemplary more advanced integrated solutions wherein an IC 4c is integrated in a multi-chip package. The IC 4c may be used for authentication of (big) other ICs.

FIG. 3d shows an exemplary more advanced integrated solution wherein an IC 4d is integrated as IP block in a larger IC. The IC 4d may be used for authentication of the larger IC.

The hardware of the IC 4, 4a-4d is preferably made as simple and cheap as possible. Hereto, the function provided by the IC 4, 4a-4d may be limited to outputting the identifier upon request, such as provided by the exemplary IC 4 of FIG. 2.

The end node device 2, 2a-2d is typically configured to retrieve the identifier preferably a unique identifier-from the IC 4, 4a-4d. This is typically triggered by a request hereto from a verifying device 5, which may be wirelessly or wiredly communicatively connected to the end node device 2, 2a-2d.

The identifier is transmitted to the centralized code registration system 3 to authenticate the identifier. Further security measures in the end node device 2, 2a, 2b may be minimized or even discarded.

The identifier is typically linked to an asset or article to which the end node device 2, 2a-2d is attached or linked. Hereto the identification code that is stored in the centralized code registration system 3 may be stored together with a vendor identification code, enabling an identifier and vendor identifier combination, both typically obtained by the end node device 2, 2a-2d, to be checked against an expected identification code and vendor identification code combination stored in the centralized code registration system 3.

In case the identifier and vendor identifier are used at the end node device 2, 2a-2d in a non-authorized combination, the centralized registration system 3 may return a negative verification result to the end node device 2, 2a, 2b, indicative of a failed authentication.

Alternatively or additionally, in case of a negative verification result the centralized registration system 3 may block the identification code from any future use, resulting in future verification results for this identification code to be negative by default.

FIG. 3e shows a non-limiting exemplary asset 6a that includes an end node device, e.g. the end node device 2b of FIG. 3b. The asset 6a may be a non-electronic asset. The identify stored in the IC 4b may be wirelessly requested by verifying device 5a, e.g. using RF-ID or any other suitable wireless communication technology. The identity received in the verifying device 5a may be transmitted to a centralized code registration system 3 for verification.

FIG. 3f shows another non-limiting exemplary asset 6b that includes an end node device, e.g. the end node device 2a of FIG. 3a. The asset 6b may be an electronic asset. The identify stored in the IC 4a may be requested by verifying device 5b, which in this example is a part of the asset 6b but may be external to the asset 6b. The identity received in the verifying device 5b may be transmitted to a centralized code registration system 3 for verification.

An identifier may be generated before or during the production process of ICs 4, 4a-4d. This is illustrated in FIG. 1 as the code generation service that generates the identifiers and stores the generated identifiers or identification codes representative of the identifiers in database 31 of the centralized registration system 3. The generated identifiers may be transmitted to the IC Manufacturing (Foundries) as a unique customer and ID encoding instructions.

The ICs 4, 4a-4d are preferably manufactured in a cost efficient manner, typically involving a lithography back-end processes followed by a so-called mid-end lithographic process step. In the back-end process the dies on a wafer 5 may be prepared to a common design, e.g. in a CMOS based, front end lithographic operation typically applying masked lithographic equipment. In the subsequent mid-end process step, a wafer based maskless lithographic operation may manipulate a predefined CMOS based IC for encoding each die of a wafer with the identifier-preferably a unique identifier-generated by the code generation service.

The implementation of the identifier in the mid-end lithographic process step advantageously allows commonly known and cost effective front end processes to remain unmodified. The mid-end lithographic process step may be integrated as a maskless lithography operation, which is found to be very suitable for uniquely encoding IC based electronic devices. In such a set-up maximum advantage may be taken from cost reduction as has over the past decades been effected in so called front-end chap manufacturing fab's or so called foundries.

Advantageously, in the authentication system 1 according to the present invention, most or all security may be transferred to the centralized code registration system 3, which is preferably implemented in the cloud. Every application system, e.g. retail, may have a database 31 with the registered identification codes ICs 4, 4a-4d that have been produced and as many associated data labels as are required (dates, type of product, manufacturer, etcetera). These data labels may be stored as or together with vendor identification codes in the database 31. When an IC 4, 4a-4d is queried for its identifier, the identifier may be sent to the database system 31 for verification of its validity, possibly with a simple “Yes” (or other indication of a positive verification result) or “No” (or other indication of a negative verification result) as outcome.

The database system 31 may advantageously take the context of verification requests into account in processing the current verification request. Examples hereof are a number of requests made in a predefined time interval, the total number of requests made, time of the request, location of the request, and etcetera. Contextual information may be transmitted as contextual data from the verifying device 5 to the centralized code registration system 3 and/or generated in the centralized code registration system 3. Part or all of the contextual data may be generated in the end node device 2, 2a-2d.

Hackers may want to try to replicate or falsify end node devices. Duplication of an end node 2, 2a-2d with IC 4, 4a-4d in an authentication system 1 according to the present invention no longer makes any sense, because this may immediately be detected, and the identity/identification code be blocked for use. Although the identifiers can in principle be public-there is nothing to hide-they may be encrypted during communication with the centralized code registration system 3, which may be implemented as a cloud server 3. In other words, hacking the end node 2, 2a-2d does not make any sense, all security processing takes place in the cloud server 3. The IC end node thus acts as a hardware anchor (e.g. to attach the code to a physical device) in an otherwise centralized secure system 3. So, although the end nodes 2, 2a-2d could be hacked (e.g. copied), the system 1 remains secure.

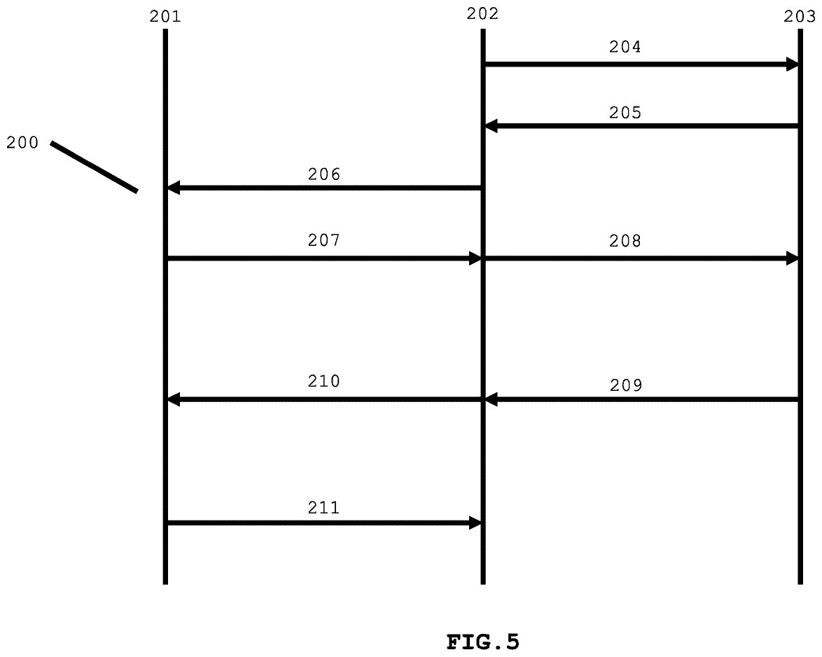

FIG. 4 shows an exemplary method according to an aspect of the invention, in the form of a time-sequence diagram. In step 100 an identification code representative of an identifier of an IC 4, 4a-4d may be stored in the centralized code registration system 3, typically in an electronic database system 31 of the centralized code registration system 3. This is typically done before or during the manufacturing process of the IC 4, 4a-4d. The end node device 2, 2a-2d may read 102 the identifier from the IC 4, 4a-4d after a request 101 from the verifying device 5. In steps 103 and 104 the identifier may be transmitted to the centralized code registration system 3, typically via the verifying device (step 103). In step 105 the centralized code registration system 3 may verify the received identifier against the corresponding stored identification code to obtain a verification result. In step 106 the verification result may be transmitted from the centralized code registration system 3 to the verification system 5, additionally or alternatively to the end node device 2, 2a-2d or any other device that may use the verification result.

The previous embodiments describe an authentication system for identification of an integrated circuit. For example, the above embodiments disclose an integrated circuit which can perform identification, that is, the disclosed integrated circuits are hard-coded with a unique identity which they output on request. A benefit of this minimalistic design is that the IC can be extremely small and simple, and thus consume less energy and be simpler to produce. In some applications, further security might be warranted. For example, for some applications it might be necessary to protect against an adversary, who intercepts the identity of a particular IC once, and from then on can reproduce the particular IC without access to the IC.

The next embodiments will disclose an authentication system which performs identification and authentication of an integrated circuit, such as to overcome this drawback.

This is done by adding a second, challenge/response step to the IC functionality. In a preferred embodiment, the standard hash-based message authentication (HMAC) function using the SHA2-256 algorithm, can be used. A standard notation for this is HMAC-SHA2-256. In principle, any of the hash-based message authentication functions using SHA2-224, SHA2-384, SHA2-512, SHA2-512/224, SHA2-512/256, SHA3-224, SHA3-256, SHA3-384, SHA3-512, SHAKE128, or SHAKE256 can be used. However, other algorithms can be used as well. Asymmetric cryptography schemes or other MAC schemes, like CMAC, can be used as an alternative. Other options are e.g. CHAP (RFC1994), or cryptography schemes like Kerberos.

In the communication flow, an additional step can be to send a challenge to the IC, which then calculates the response using the chosen algorithm and a secret key or secret key material derived from the key. The challenge can preferably originate from the server. The response can then be sent to the server, which can verify whether the response is valid or not.

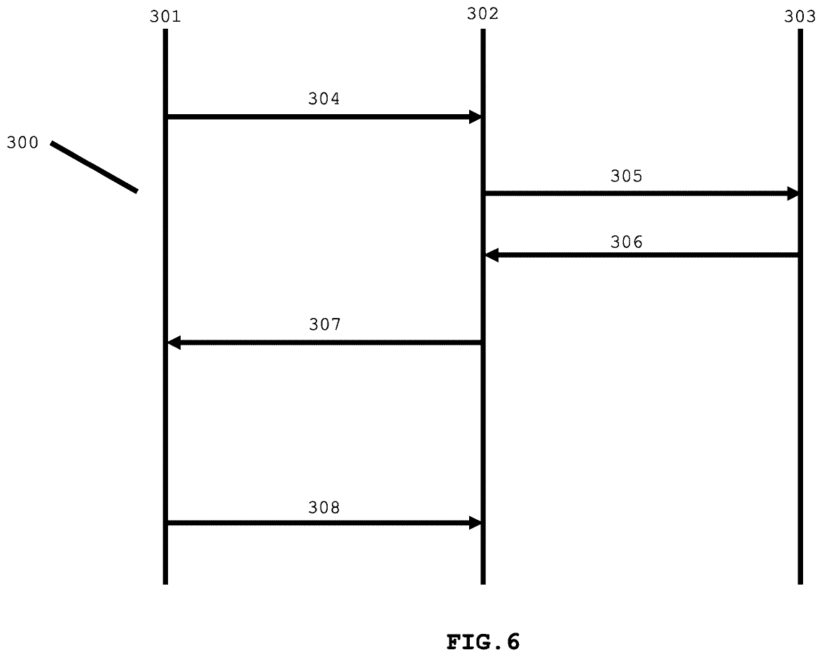

FIG. 5 shows a schematic overview of an identification and authentication method 200 according to a first embodiment.

A terminal 202 can communicate with a server 201 and a IC 203 according to the present invention.

The terminal 202 can be an entity or device that needs to be convinced of the identity of the end node (containing the IC). The terminal can be a part of the end node. Thus, the terminal 202 can need a connection to the IC, direct or indirect, to be able to communicate with the IC. Furthermore, the terminal 202 can need to be able to communicate with the server to verify the identity of the IC and/or perform the challenge/response process.

The server 201 can be an entity or device that is equipped to answer an identity request and/or an authentication request. The server can be a cloud service or be a device with a connection to the cloud service. The cloud service can be the source of truth for all ICs, i.e. it can determine whether an IC is to be trusted or not. A (local) server can be equipped with challenge-response pairs for the specific IDs of ICs the local server is expected to communicate with. Pre-processing can be performed in the IC, the end node, the terminal and/or on the server. One could also store the authenticity requests on a server and decide on authenticity later. Reference can be made to US provisional patent application with application number U.S. Ser. No. 63/030,944, which sees on an ID management system.

In step 204 an identity request is sent from the terminal 202 to the IC 203. This identity request can be sent because the server wishes to connect to the IC and/or vice versa.

In step 205 an identity message is sent by the IC to the terminal. The identity message can be generated by the IC on the basis of a particular identity value stored therein and can be sent by the end node which comprises the IC 203 to the terminal 202.

In step 206 the terminal 202 sends the identity message to the server 201. Next an internal security check takes place, in which it can be verified, by the server 201 whether the received identity message matches a particular first value which is stored in the server and which is associated with the integrated circuit in the end node, wherein a different first value is stored for each different identity value of the IC 203.

The steps describe above generally correspond to the authentication method described above which relates to identification of the IC 203. If the identification of the IC 203 is successful, e.g. if the first value stored on the server 201 matches the identity value stored on the IC 203, a challenge message is sent from the server to the terminal in step 207. This challenge message is part of a challenge-response algorithm as described above. In this way, the identity of the IC 203 can be authenticated.

In step 208, the terminal 202 sends the challenge message to the IC 203, e.g. via the end node that comprises the IC 203. Next, the IC generates a challenge-response message on the basis of a pre-determined function, the challenge message, and an authentication value. The pre-determined function is for example a hash function as described above. The authentication value can be a secret key or secret key material which derived from the secret key. The authentication value is stored on the IC 203.

The identity value and the authentication value can be stored in the end node, in particular in the IC 203 in such a way that the identity value and/or the authentication value is hard-coded into the integrated circuit 203 in the end node.

In order to generate the challenge-response message, the IC 203 must include hardware circuitry to calculate the response based on the received challenge message. The manner in which the challenge-response message is generated will be further described below.

In step 209 the challenge-response message is sent from the IC 203 to the terminal 202, e.g. via the end node that comprises the IC 203. In step 210, subsequently, the terminal 202 sends the challenge-response through to the server 201.

Next, the server verifies the received challenge-response message on the basis of a second value, the challenge message and a pre-determined function. By doing so, the server obtains a verification result. The second value is associated with the integrated circuit in the end node, wherein a different second value is stored in the server for each different authentication value. The pre-determined function is the same function as was used in order to generate the challenge-response message, or a function related to that function, such as for example the inverse function. In a preferred embodiment, if the pre-determined function is the hash-based message authentication (HMAC) function using SHA2-256, then the pre-determined functions are the same and equal to SHA2-256.

The verification result can signify whether the authentication of the IC 203 is verified by the server or not. For example, if the server is able, by using the pre-determined function to generate the same challenge-response message as was generated by the IC 203, the server 201 verifies the IC 203.

In step 211, an authentication result can be sent to the terminal 202 on the basis of the verification result. The challenge-response check has now been performed, and the IC 203 has been authenticated (or not).

If the IC 203 has been identified and authenticated, the server has determined that the IC 203 is a valid IC 203 which can be trusted. If the IC 203 has been identified but not authenticated, the server has determined that the IC 203 is not a valid IC 203 and thus cannot be trusted.

As mentioned above the identification value can be hard-coded into the IC 203. This has the same benefits as were argued above. Furthermore, the authentication value can be hard-coded into the IC 203. This can make the IC as minimal as possible, since there will be less microcontroller unit (MCU) or memory that needs to be available to guarantee it is immutable. In a preferred embodiment, both the identification value and the authentication value are hard-coded, no MCU nor memory will need to be available to guarantee immutability. This minimizes the IC design even more.

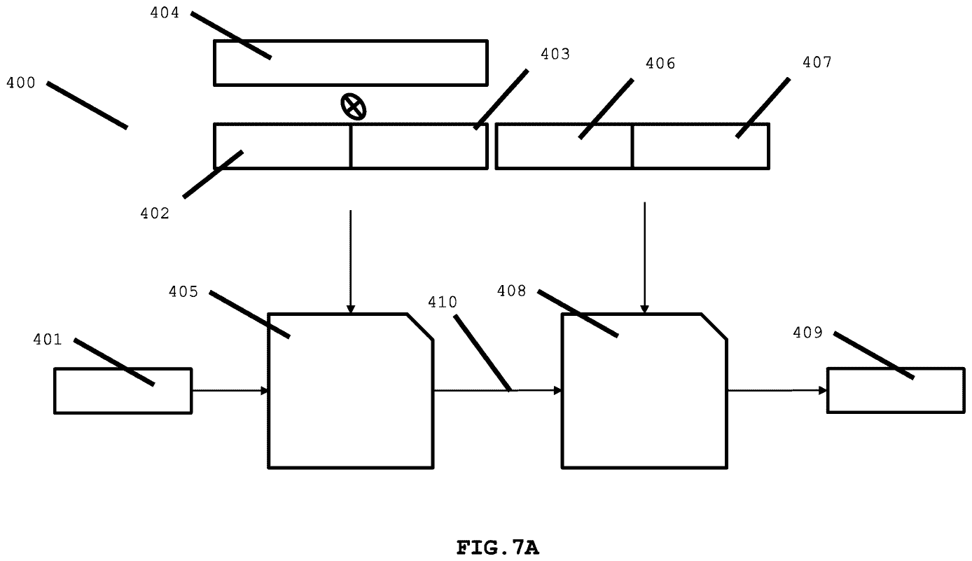

FIG. 6 shows a schematic overview of an identification and authentication method 300 according to a second embodiment.

In step 304, the server 301 sends a challenge message to the terminal 302, for authenticating the IC 303. In this method 300, the challenge is not sent after the identification of the IC 303 has been checked.

In step 305, the terminal 302 sends an identification and authentication request to the IC 303. This request contains the challenge message generated by the server 301. An identity message can be generated by the IC 303 on the basis of a particular identity value stored therein. Furthermore, the IC 303 generates a challenge-response message on the basis of a pre-determined function, the challenge message, and an authentication value, as was discussed above. The pre-determined function is for example a hash function as described above. The authentication value can be a secret key or secret key material which derived from the secret key. The authentication value is stored on the IC 303.

The identity value and the authentication value can be stored in the end node, in particular in the IC 303 in such a way that the identity value and/or the authentication value is hard-coded into the integrated circuit 303 in the end node.

Next, in step 306, the IC 303 sends the identity message and the challenge-response message to the terminal 302. The identity message and the challenge-response message can be embedded in the same message, or can form separate messages. The messages can be sent subsequently.

In step 307, the terminal 302 sends the received identity message and the challenge-response message to the server 301. Next, an internal security check is performed, wherein the received identity message is verified on the basis of a first value and the received challenge-response message is verified on the basis of a second value, the challenge message and the pre-determined first function, so as to obtain a verification result. Here, the first value is stored in the server and is associated with the integrated circuit in the end node, wherein a different first value is stored for each different identity value of the IC 303. The second value is associated with the integrated circuit in the end node, wherein a different second value is stored in the server for each different authentication value.

The pre-determined function is the same function as was used in order to generate the challenge-response message, or a function related to that function, such as for example the inverse function. In a preferred embodiment, if the pre-determined function is the hash-based message authentication (HMAC) function SHA2-256, then the pre-determined functions are the same and equal to SHA2-256.

The verification result can signify whether the authentication of the IC 303 is verified by the server or not. For example, if the server is able, by using the pre-determined function to generate the same challenge-response message as was generated by the IC 303, the server 301 verifies the IC 303.

In step 308, an authentication result can be outputted by the server and sent to the terminal 302 on the basis of the verification result. The challenge-response check has now been performed, and the IC 303 has been authenticated (or not).

The second method 300 has the advantage of needing fewer communication rounds. However, a challenge needs to be generated (and communicated) before the identity of a particular IC is claimed to the server.

Next, the generation of the challenge-response message on the basis of the challenge message is explained. In the below embodiment, the standard hash-based message authentication (HMAC) function using SHA2-256 algorithm is used. However, other algorithms can be used as well, for example as listed above.

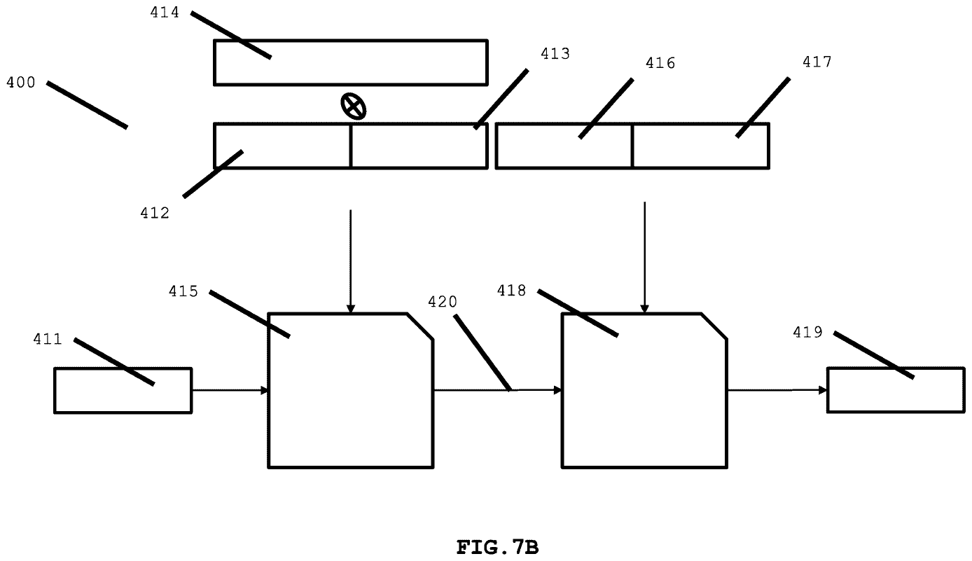

FIG. 7A shows a schematic overview of a first hash pass 400 in a SHA-256 algorithm.

An initial value 401, having a size of 256 bits and being a standard value in SHA-256 is used as input to a compression function 405. Here the compression function indicates a function which performs message pre-processing and a hash core which performs the hash functionality. A secret key 402, of 256 bits in size is padded with padding 403 consisting of zeroes of 256 bits in size. Next, this is XOR-ed with 512 bits message 404, for example consisting of 5C5C5C . . . 5C. This is a so-called white noise sequence. This XOR-ed input message is used as input to the compression function 405 as well. The compression function outputs an intermediate hash 410.

This intermediate hash 410 is used as input to a second compression function 408. The first and second compression functions are the same. The other input to the second compression function 408 is a challenge word 406 of 256 bits in size length padded to a total of 512 bits by padding with a padding 407 of 256 bits in size. The padding 407 can be for example 80 00 . . . 00 80. The second compression function 408 outputs a hash value 409 of 256 bits in size.

FIG. 7B shows a schematic overview of a second hash pass 400 in a SHA-256 algorithm.

This second hash pass is performed after the first hash pass, and uses instead of the challenge word 406 the hash value 409 of the first hash pass, and a different padding for the input message to the first compression function. The rest of the input remains the same. In other words, an initial value 411, having a size of 256 bits and being a standard value in SHA-256 is used as input to a compression function 415. This initial value is the same as in the first hash pass. The compression function 415 is the same as in the first hash pass. The secret key 412, of 256 bits in size is padded with padding 413, e.g. with zeroes of 256 bits in size. Again, the secret key 412 is the same secret key as the secret key 402 in the first hash pass. Next, this is XOR-ed with 512 bits message 404, for example consisting of 363636 . . . 36. This again is a so-called white noise sequence. This XOR-ed input message is used as input to the compression function 415 as well. The compression function outputs an intermediate hash 420.

This intermediate hash 420 is used as input to a second compression function 418. The first and second compression function are the same. The other input to the second compression function 418 is the hash value 416 that was the end result of the first hash pass and is 256 bits in size, length padded to a total of 512 bits by padding with a padding 417 of 256 bits in size. The padding 417 can be for example 80 00 . . . 00 80. The second compression function 418 outputs a response word 419 of 256 bits in size. The response word 419 can be used to generate the challenge-response message.

The secret key 402, 412 can be hard-coded on the IC. This can make the IC as minimal as possible, since there will be less microcontroller unit (MCU) or memory that needs to be available to guarantee it is immutable.

As can be noted from the above, the first and second hash pass in a standard HMAC SHA2-256 algorithm always respectively generate the same intermediate hash output, because the input to the first compression function is the same in both respective passes.

When calculating an HMAC, depending on the length of the challenge at least four computations of the so-called compression function (as defined by the SHA standard NIST. FIPS. 180-4) have to be performed. However, as for each particular IC the secret key 402, 412 used for authentication is fixed, two of these computations always are performed with the same inputs.

Thus, the intermediate hash values 410, 420 can be pre-calculated and the results can be hard-coded on the IC (instead of the key 402, 412) and never perform the two computations that produce them.

This has as an additional benefit that the secret key for authentication is never directly available on the IC itself; only these intermediate values for the HMAC calculation.

The entire first hash can thus be replaced by a fixed input, which makes the first compression function superfluous in the IC. This saves two times 64 Word CLK cycles of operation and avoids having to store the 256-bit Initial Value word in a ROM. Furthermore, it avoids having to write the key on the IC. Overall this results in an efficiency improvement.

This can simplify the design considerably of the IC, since only two SHA2-256 compression function calls are required, furthermore two 256-bit words to be written on the chip the intermediate hash values 410, 420. The padding and constants K (used to define the workings of the compression function) are fixed words, for example in ROM. The total operation can be done in two successive 64 Word CLK cycles.

Thus, either the secret key is used can be the authentication value in the end node and for example hard-coded into the IC, or the intermediate hash values can be used as the authentication values in the end node and for example hard-coded into the IC. Of course, also a single intermediate hash value can be used as an authentication value, and the other can still be calculated using the secret key, although this is not preferred.

The secret key or the authentication values may be embedded in the IC as a bit-code of predefined order of magnitude, hard coded in the IC, typically in the form of a register and an interface for reading out the code.

If the secret key is used as the authentication value, or if one or more intermediate hash values are used as the authentication value, the second value stored on the server can correspond to either the secret key, or can correspond to the one or more intermediate hash values. In a preferred embodiment, the second value corresponds to the secret key since in some configurations this requires less storage space.

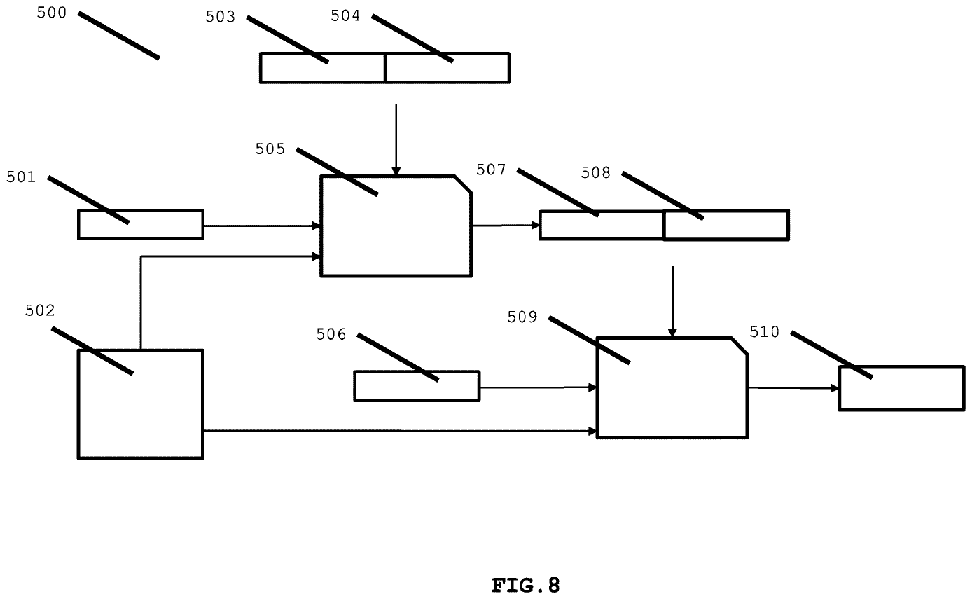

FIG. 8 shows a schematic overview of an implementation of a hash-based message authentication code.

In this case, the first and second intermediate hash values 501, 506 have been pre-computed and are used as input to the second compression function 505, 509 in the first and second hash pass respectively. The second compression functions 505, 509 are the same, and are defined by constants K₀-K₆₃, which are constants of 32 bits and thus form 64 words. Each of the two compression functions take 64 word CLK cycles to perform their functionality.

As further input, the second compression function of the first hash pass 505 takes a challenge word 503 of 256 bits in size length padded to a total of 512 bits by padding with a padding 504 of 256 bits in size. The padding 504 can be for example 80 00 . . . 00 80. The second compression function 505 outputs a hash value 507 of 256 bits in size.

As further input, the second compression function of the second hash pass 509 takes the hash value 507 that was the end result of the first hash pass and is 256 bits in size, length padded to a total of 512 bits by padding with a padding 508 of 256 bits in size. The padding 508 can be for example 80 00 . . . 00 80. The second compression function 509 outputs a response word 510 of 256 bits in size. The response word 510 can be used to generate the challenge-response message.

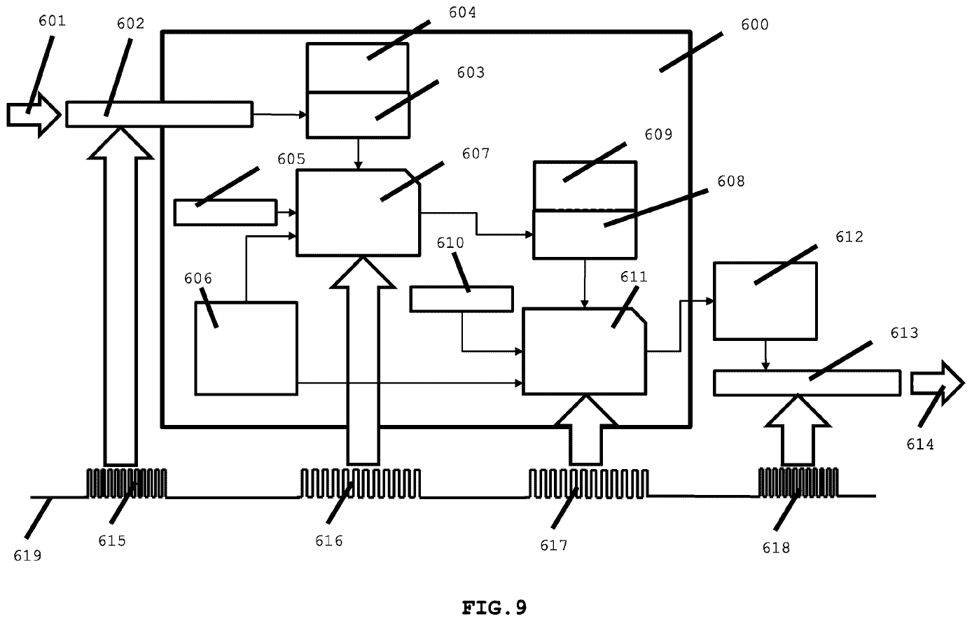

FIG. 9 shows a schematic overview of a high-level challenge-response flow in the IC.

Input 601 is transmitted to the IC, for example the HMAC core 600. The input 601 comprises a challenge word 602 and can be transferred sequentially via a serial port. The transmitted challenge word comprising for example 8 words forms for example the most significant bits of an input to a compression function 607 part of a first hash pass, while the least significant bits are formed by a padding 604, for example 80 00 . . . 00 80 of 256 bits. The other inputs to the compression function 607 is the intermediate hash value 605 form the first part of the first hash pass, and the constant 606 comprising constants K₀-K₆₃, which are constants of 32 bits and thus form 64 words and which define the compression function 607. The intermediate hash value 605 is pre-determined in this embodiment.

The hash value 608 which is the output of the compression function of the first hash pass is used as for example the most significant bits, together with padding 609, for example 80 00 . . . 00 80 of 256 bits, which form the least significant bits, as input to a compression function 611 of a second hash pass. The other input to the compression function 611 are the constants 606 which define the compression function 611, and the intermediate hash value 610 from the first pass of the second hash pass. The intermediate hash value 605 is pre-determined in this embodiment.

The compression function 611 outputs a response word 612 comprising for example eight words. The response word can be transferred in a sequence 613 via a serial port into an output 614.

The line 619 denotes the SCLK line of the SPI interface-it denotes the clock signal being sent to the IC. In order to serial in the challenge word comprising 256 bits, in the above example 256 clock cycles, denoted by reference numeral 615, are performed. In order to generate the hash value 608, the compression function 607 uses 64 cycles, so 64 clock cycles are used, denoted by reference numeral 616, are performed. In order to generate the response word 612, the compression function 611 also uses 64 cycles, so again 64 clock cycles are used, denoted by reference numeral 617, are performed. In order to serial out the response word comprising 256 bits, in the above example 256 clock cycles, denoted by reference numeral 618, are performed.

Because the intermediate hash values 605, 610 have been pre-determined and stored on the IC, for example hard-coded on the IC, the clock cycles using a first compression function in a first part of a first and second hash pass do not have to be performed. Normally, this would take 64 cycles for each compression function, so two times 64 clock cycles are saved in this manner. The above described process and implementation method is thus faster than conventional HAMC process and implementation methods.

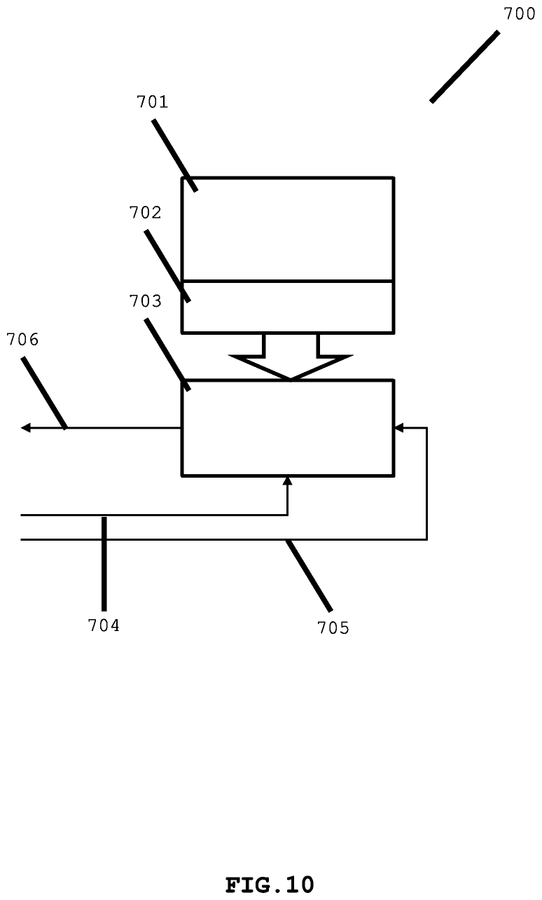

FIG. 10 shows identification functionality 700 of an IC, which can work in parallel from an authentication functionality.

The identification value can for example comprise a 128 bits identification code 701 of the IC, the identification value can be stored on the IC and can be for example hard-coded on the IC as in the above embodiments. Furthermore, a vendor value can for example comprise a 32 bits vendor code 702. The identification value and/or the vendor value may be embedded in the IC as a bit-code of predefined order of magnitude, hard coded in the IC, typically in the form of a register and an interface for reading out the code.

When for example prompted, the IC can output the identification value and/or the vendor value via for example a SPI interface 703. The identification value and/or the vendor value can be serialized and outputted 701 over a serial peripheral interface (SPI) via a MISO (Master Input Slave Output) port. The interface 703 has as further input a clock 704 for performing clock cycles and a select line 705, with which it can be determined whether only the identification value and/or vendor value is sent over the interface, or whether also the challenge-response processing is performed. Setting the select line 705 to a low signal for example can act as a start signal for the IC. The IC can then execute one step on each clock cycle it receives on the SCLK line. The challenge-response functionality can use the same SPI interface. By sharing the SPI interface 703, a minimal chip design is possible. The challenge-response mechanism can also use SPI MOSI IN for receiving the challenge word, for example.

By this design, the identification and challenge-response functionality can be independent.

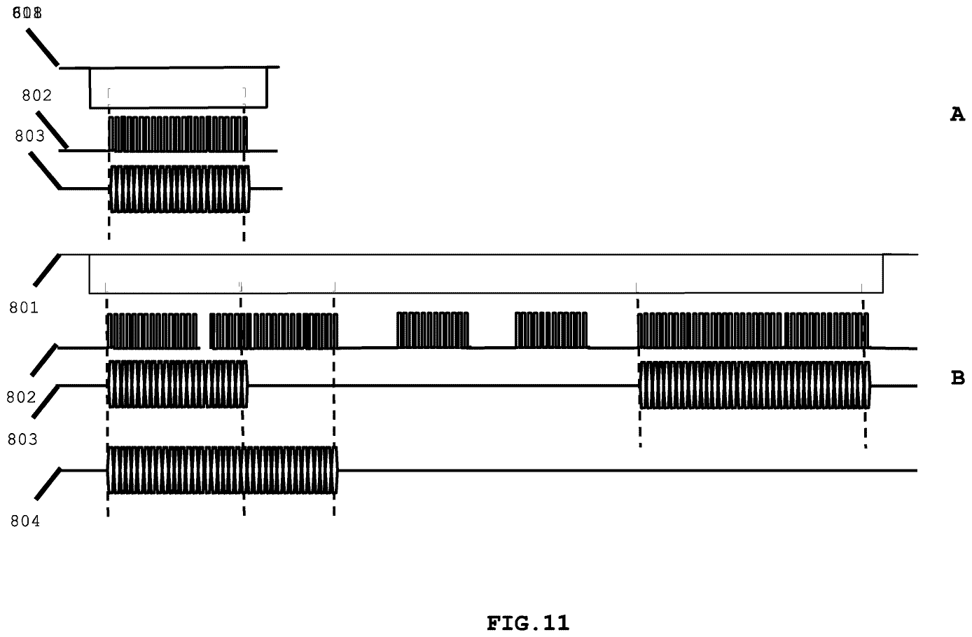

FIG. 11A-B show a schematic overview of an implementation of a identification and authentication method and its usage of clock cycles on the IC.

The select line 801 determines whether only the identification value and/or vendor value is sent over the interface, or whether also the challenge-response processing is performed. The former is depicted in FIG. 11A, the latter in FIG. 11B. The clock line indicates whether a clock cycle is active or not. The SPI OUT line 803 indicates whether a clock cycle is used to e.g. sequentially send an identification and/or vendor code, or a e.g. a response word. The SPI IN line 804 can be used when the select line determines that challenge-response processing is performed. In this way, a clock cycle can be used to sequentially receive e.g. a challenge word.

In FIG. 11A, e.g. 160 clock cycles are performed in order to send a vendor code and an identification code (together 160 bits) over the SPI OUT line 803.

IN FIG. 11B, first, e.g. 160 clock cycles are performed in order to send a vendor code and an identification code (together 160 bits) over the SPI OUT line 803. After the 160 clock cycles the identification code and vendor code block is preferably switched off. In parallel 256 clock cycles can be used in order to receive a challenge word of 256 bits. So, in this embodiment, the first 256 clock cycles are used to in parallel (1) output the VC+ID on the MISO line and (2) input the challenge word. Since the challenge word is 256 bits, this takes 256 clock cycles (of which the latter 256−160=96 will have no output on the MISO line).

Next, after the challenge word has been received, two times 64 clock cycles are used as described above to generate a response word. Finally, 256 clock cycles are used to transmit the response word over the SPI OUT line.

The below clauses describe further embodiments of the invention:

Clause 1. An authentication method for authenticating the identity of an end node by an authentication system, comprising:
storing, in the end node, an identity value (ID) and an authentication value, wherein the identity value and/or the authentication value is hard-coded into an integrated circuit in the end node;
storing, in the authentication system, a first value associated with the integrated circuit in the end node, wherein a different first value is stored for each different identity value;
storing, in the authentication system, a second value associated with the integrated circuit in the end node, wherein a different second value is stored for each different authentication value;
receiving a challenge message by the end node;
receiving, by the authentication system, an identity message, wherein the identity message is generated by the end node on the basis of the identity value (ID) stored in the end node;
receiving, by the authentication system, a challenge-response message, wherein the challenge-response message is generated by the end node on the basis of a pre-determined first function, the challenge message, and the authentication value stored in the end node;
verifying, by the authentication system, the received identity message on the basis of the first value and verifying, by the authentication system, the received challenge-response message on the basis of the second value, the challenge message, and a pre-determined first function, so as to obtain a verification result; and
outputting, by the authentication system, an authentication result on the basis of the verification result.

Clause 2. The authentication method according to clause 1, wherein the authentication value stored in the end node is derived using a pre-determined initial value, an initial key specific to the integrated circuit in the end node, and a pre-determined second function.

Clause 3. The authentication method according to clause 2, wherein the pre-determined second function is equal to the pre-determined first function.

Clause 4. The authentication method according to clause 2 or 3, wherein the initial key corresponds to the second value stored in the authentication system.

Clause 5. The authentication method according to any one of clause 2-4, wherein the pre-determined first function and the pre-determined second function are hash functions, and the authentication value is a hash output of the pre-determined second function.

Clause 6. The authentication method according to clause 5, wherein the pre-determined first and second functions each form a cryptographic hash function of a hash-based message authentication code.

Clause 7. The authentication method according to clause 6, wherein the hash-based message authentication code uses the hash function SHA2-224, SHA2-256, SHA2-384, SHA2-512, SHA2-512/224, SHA2-512/256, SHA3-224, SHA3-256, SHA3-384, SHA3-512, SHAKE128, or SHAKE256.

Clause 8. The authentication method according to any one of the preceding clauses, wherein verifying the received identity message comprises verifying whether the first value corresponds to the contents of the identity message.

Clause 9. The authentication method according to any one of the preceding clauses, wherein verifying the received challenge-response message comprises: generating a challenge-response value on the basis of the second value, the challenge message, and the pre-determined first function; and verifying whether the challenge-response value corresponds to the contents of the challenge-response message.

Clause 10. The authentication method according to any one of the preceding clauses, wherein the challenge message is received by the end node after the verification of the received identity message by the authentication system.

Clause 11. The authentication method according to any one of clauses 1-9, wherein the challenge-response message is received by the authentication system together with the identity message.

Clause 12. The authentication method according to any one of the preceding clauses, wherein the identity message is received by the authentication system after an identity verification request is received by the end node.

Clause 13. The authentication method according to any one of the preceding clauses, wherein the verification result is at least partly based on contextual data, the contextual data preferably including one or more of a number of verifying requests made in a predefined time interval, a total number of verifying requests made, a time of a verifying request, a geographical location of the integrated circuit, a geographical location from where a verifying request is made.

Clause 14. The authentication method according to any one of the preceding clauses, further comprising transmitting the authentication result from the authentication system to the end node device.

Clause 15. The authentication method according to any one of the preceding clauses, wherein the integrated circuit comprises a read-only register (41) comprising the identification value and/or the authentication value and an interface (MISO) for reading the identification value and/or the authentication value from the register and outputting (102) the identification value and/or the authentication value.

Clause 16. The authentication method according to any one of the preceding clauses, wherein the functionality of the integrated circuit is limited to providing the identity message and the challenge-response message.

Clause 17. The authentication method according to any one of the preceding clauses, wherein the authentication system comprises a data storage system for storing the first value and the second value of each of the integrated circuits, wherein the first value and the second value has been stored in the electronic database system upon implementation of the identification value and authentication value in the integrated circuit.

Clause 18. The authentication method according to clause 17, wherein the data storage system is secured by at least one of restricted access, data encryption, or being located in a secured environment.

Clause 19. The authentication method according to any one of the preceding clauses, comprising:
storing, in the end node, a vendor value;
storing, in the authentication system, the first value and the second value together with a third value, the third value being indicative for a system owner of an asset that is associated with the first value, wherein a different third value is stored for each different vendor value;
receiving, by the authentication system, a vendor message together with the identity message, wherein the vendor message is generated by the integrated circuit in the end node on the basis of the vendor value; and
verifying, by the authentication system, the received vendor message on the basis of the third value to obtain the verification result.

Clause 20. The authentication method according to any one of the preceding clauses, further comprising registering, in the authentication system, the first value as being invalid in case the verification result is negative, resulting in future verification results for this first value to be negative by default.

Clause 21. The authentication method according to any one of the preceding clauses, wherein the identity value and the authentication value are each unique values used only once amongst the integrated circuits in the plurality of end node devices.

Clause 22. The authentication method according to any one of the preceding clauses, wherein the authentication system is implemented as a cloud service.

Clause 23. The authentication method according to any one of the preceding clauses, wherein the plurality of end node devices include Internet-of-Things devices.

Clause 24. A method of manufacturing an integrated circuit, the integrated circuit for use in an authentication method according to any one of the clauses 1-23, the method comprising:
generating an identity value (ID) and an authentication value in a server;
storing (100), in the server, a first value representative of the identity value and a second value representative of the authentication value; and
providing the identity value (ID) and/or the authentication value to an IC manufacturing facility, wherein the identity value (ID) and/or the authentication value is hard-coded in the integrated circuit.

Clause 25. An authentication system comprising:
a plurality of end nodes, wherein in each end node an identity value (ID) and an authentication value is stored, wherein the identity value and/or the authentication value is hard-coded into an integrated circuit in the end node;
a data storage system arranged to store for each end node a first and second value associated with the integrated circuit in the end node, wherein a different first value is stored for each different identity value and a different second value is stored for each different authentication value;
a terminal arranged to transmit a challenge message to an end node, and receive from the end node an identity message and a challenge-response message, wherein the identity message is generated by the end node on the basis of the identity value (ID) stored in the end node, and wherein the challenge-response message is generated by the end node on the basis of a pre-determined first function, the challenge message, and the authentication value stored in the end node;
a server arranged to verify the received identity message for the end node on the basis of the first value, and verify the received challenge-response message for the end node on the basis of the second value, the challenge message, and the pre-determined first function, so as to obtain a verification result, and arranged to output an authentication result on the basis of the verification result for the end node.

Clause 26. The authentication system according to clause 25, wherein the terminal is arranged to receive the challenge message for the end node from the server and transmit the identity message and the challenge-response message from the end node to the server.

Clause 27. The authentication system according to clause 25 or 26, wherein the authentication value is obtained by using a pre-determined initial value, an initial key specific to the integrated circuit in the end node and a pre-determined second function.

Clause 28. The authentication system according to clause 27, wherein the pre-determined second function is equal to the pre-determined first function.

Clause 29. The authentication system according to clause 27 or 28, wherein the initial key corresponds to the second value stored in the authentication system.

Clause 30. The authentication system according to anyone of clauses 27-29, wherein the pre-determined first function and the pre-determined second function are hash functions, and the authentication value is a hash output of the pre-determined second function.

Clause 31. The authentication system according to clause 30, wherein the pre-determined first and second functions each form a cryptographic hash function of a hash-based message authentication code.

Clause 32. The authentication system according to clause 31, wherein the hash-based message authentication code uses the hash function SHA2-224, SHA2-256, SHA2-384, SHA2-512, SHA2-512/224, SHA2-512/256, SHA3-224, SHA3-256, SHA3-384, SHA3-512, SHAKE128, or SHAKE256.

Clause 33. The authentication system according to any one of clauses 25-32, wherein verifying the received identity message comprises verifying whether the first value corresponds to the contents of the identity message.

Clause 34. The authentication system according to any one of clauses 25-33, wherein verifying the received challenge-response message comprises: generating a challenge-response value on the basis of the second value, the challenge message, and the pre-determined first function; verifying whether the challenge-response value corresponds to the contents of the challenge-response message.

Clause 35. The authentication system according to any one of clauses 25-34, wherein the challenge message is received by the end node after the verification of the received identity message by the authentication system.

Clause 36. The authentication system according to any one of clauses 25-34, wherein the challenge-response message is received by the authentication system together with the identity message.

Clause 37. The authentication system according to any one of clauses 25-36, wherein the identity message is received by the authentication system after an identity verification request is received by the end node.

Clause 38. The authentication system according to any one of clauses 25-37, wherein the verification result is at least partly based on contextual data, the contextual data preferably including one or more of a number of verifying requests made in a predefined time interval, a total number of verifying requests made, a time of a verifying request, a geographical location of the integrated circuit, a geographical location from where a verifying request is made.

Clause 39. The authentication system according to any one of clauses 25-38, further comprising transmitting the authentication result from the centralized code registration system to the end node device.

Clause 40. The authentication system according to any one of clauses 25-39, wherein the integrated circuit comprises a read-only register (41) comprising the identification value and/or the authentication value and an interface (MISO) for reading the identification value and/or the authentication value from the register and outputting (102) the identification value and/or the authentication value.

Clause 41. The authentication system according to any one of clauses 25-40, wherein the functionality of the integrated circuit is limited to providing the identity message and the challenge-response message.

Clause 42. The authentication system according to any one of clauses 25-41, wherein the authentication system comprises a data storage system for storing the first value and the second value of each of the integrated circuits, wherein the first value and the second value has been stored in the electronic database system upon implementation of the identification value and authentication value in the integrated circuit.

Clause 43. The authentication system according to clause 42, wherein the data storage system is secured by at least one of restricted access, data encryption or being located in a secured environment.

Clause 44. The authentication system according to any one of clauses 25-43, comprising: storing, in the end node, a vendor value; storing, in the authentication system, the first value and the second value together with a third value, the third value being indicative for a system owner of an asset that is associated with the first value, wherein a different third value is stored for each different vendor value; receiving, by the authentication system, a vendor message together with the identity message, wherein the vendor message is generated by the integrated circuit in the end node on the basis of the vendor value; verifying, by the authentication system, the received vendor message on the basis of the third value to obtain the verification result.

Clause 45. The authentication system according to any one of clauses 25-44, further comprising registering, in the authentication system, the first value as being invalid in case the verification result is negative, resulting in future verification results for this first value to be negative by default.

Clause 46. The authentication system according to any one of clauses 25-45, wherein the identity value and the authentication value are each unique values used only once amongst the integrated circuits in the plurality of end node devices.

Clause 47. The authentication system according to any one of clauses 25-46, wherein the authentication system is implemented as a cloud service.

Clause 48. The authentication system according to any one of clauses 25-47, wherein the plurality of end node devices include Internet-of-Things devices.

Clause 49. An integrated circuit comprising an identification value and/or an authentication value hard-coded in the integrated circuit, for use in the authentication system according to any one of the clauses 25-48.

Clause 50. The integrated circuit according to clause 49, wherein the integrated circuit comprises a read-only register comprising the identification value and/or the authentication value and an interface (MISO) for reading the identification value and/or the authentication value from the register and outputting the identification value and/or the authentication value. Clause 51. The integrated circuit according to clause 49 or 50, comprising: an SPI (Serial Peripheral Interface) and control logic for obtaining the identification value and/or the authentication value from the read-only register on a request received via the control logic; one or more voltage inputs (VDDD, VSSD, VDDIO, VSSIO); one or more signal inputs (MOSI, SCLK, CSN); and a signal output (MISO) for outputting the identification value and/or the authentication value.

Clause 52. The integrated circuit according to any one of the clauses 49-51, wherein the integrated circuit is one of: miniature SO8-packaged, SSOP8-packaged, TSSOP8-packaged or 8WLCSP-packaged for board-level applications; RF-ID compatible; integrated in a multi-chip package; integrated as IP block in a larger integrated circuit.

Clause 53. An end node device comprising the integrated circuit according to any one of the clauses 49-52, wherein the end node device is configured to read the identification value and the authentication value from the integrated circuit and transmit the identification value and the authentication value for authentication in the server.

Clause 54. Use of an integrated circuit according to any one of the clauses 49-53 in an authentication system according to any one of the clauses 25-48.

Two or more of the above embodiments can be appropriately combined.

1. An authentication method for authenticating the identity of an end node by an authentication system, comprising:
storing, in the end node, an identity value and an authentication value, wherein the identity value and/or the authentication value is hard-coded into an integrated circuit in the end node;
storing, in the authentication system, a first value associated with the integrated circuit in the end node, wherein a different first value is stored for each different identity value;
storing, in the authentication system, a second value associated with the integrated circuit in the end node, wherein a different second value is stored for each different authentication value;
receiving a challenge message by the end node;
receiving, by the authentication system, an identity message, wherein the identity message is generated by the end node on the basis of the identity value stored in the end node;
receiving, by the authentication system, a challenge-response message, wherein the challenge-response message is generated by the end node on the basis of a pre-determined first function, the challenge message, and the authentication value stored in the end node; verifying, by the authentication system, the received identity message on the basis of the first value and verifying, by the authentication system, the received challenge-response message on the basis of the second value, the challenge message, and a pre-determined first function, so as to obtain a verification result; and
outputting, by the authentication system, an authentication result on the basis of the verification result.

2. The authentication method according to claim 1, wherein the authentication value stored in the end node is derived using a pre-determined initial value, an initial key specific to the integrated circuit in the end node, and a pre-determined second function.

3. The authentication method according to claim 2, wherein the pre-determined second function is equal to the pre-determined first function.

4. The authentication method according to claim 2, wherein the initial key corresponds to the second value stored in the authentication system.

5. The authentication method according to claim 2, wherein the predetermined first function and the pre-determined second function are hash functions, and the authentication value is a hash output of the pre-determined second function.

6. The authentication method according to claim 5, wherein the pre-determined first and second functions each form a cryptographic hash function of a hash-based message authentication code.

7. The authentication method according to claim 1, wherein verifying the received identity message comprises verifying whether the first value corresponds to the contents of the identity message.

8. The authentication method according to claim 1, wherein verifying the received challenge-response message comprises:
generating a challenge-response value on the basis of the second value, the challenge message, and the pre-determined first function; and
verifying whether the challenge-response value corresponds to the contents of the challenge-response message.

9. An authentication system comprising:
a plurality of end nodes, wherein in each end node an identity value and an authentication value is stored, wherein the identity value and/or the authentication value is hard-coded into an integrated circuit in the end node;
a data storage system arranged to store for each end node a first and second value associated with the integrated circuit in the end node, wherein a different first value is stored for each different identity value and a different second value is stored for each different authentication value;
a terminal arranged to transmit a challenge message to an end node, and receive from the end node an identity message and a challenge-response message, wherein the identity message is generated by the end node on the basis of the identity value stored in the end node, and wherein the challenge-response message is generated by the end node on the basis of a pre-determined first function, the challenge message, and the authentication value stored in the end node;
a server arranged to verify the received identity message for the end node on the basis of the first value, and verify the received challenge-response message for the end node on the basis of the second value, the challenge message, and the pre-determined first function, so as to obtain a verification result, and arranged to output an authentication result on the basis of the verification result for the end node.

10. The authentication system according to claim 9, wherein the terminal is arranged to receive the challenge message for the end node from the server and transmit the identity message and the challenge-response message from the end node to the server.

11. The authentication system according to claim 9, wherein the authentication value is obtained by using a pre-determined initial value, an initial key specific to the integrated circuit in the end node and a pre-determined second function.

12. The authentication system according to claim 11, wherein the pre-determined second function is equal to the pre-determined first function.

13. The authentication system according to claim 11, wherein the initial key corresponds to the second value stored in the authentication system.

14. The authentication system according to claim 11, wherein the predetermined first function and the pre-determined second function are hash functions, and the authentication value is a hash output of the pre-determined second function.

15. An integrated circuit comprising an identification value and/or an authentication value hard-coded in the integrated circuit, for use in the authentication system according to claim 9.
